(19) United States
(12) Patent Application Publication
(10) Pub. No.: US 2014/0302280 A1
(43) Pub. Date: Oct. 9, 2014

(54) GYPSUM BOARDS MADE WITH HIGH PERFORMANCE BIO-BASED FACERS AND METHOD OF MAKING THE SAME

(71) Applicant: Georgia-Pacific Gypsum LLC, Atlanta, GA (US)

(72) Inventors: Keshav S. Gautam, Duluth, GA (US); Samuel C. Baer, Atlanta, GA (US); Hubert C. Francis, Lithonia, GA (US); Micheal S. Lerch, Roswell, GA (US)

(21) Appl. No.: 14/114,458

(22) PCT Filed: Apr. 25, 2012
(86) PCT No.: PCT/US12/34906

§ 371 Date: Mar. 31, 2014

Related U.S. Application Data
(60) Provisional application No. 61/480,920, filed on Apr. 29, 2011.

(51) Int. Cl. E04C 2/04; C04B 20/00; C04B 28/14; C04B 18/24; E04C 2/16; E04C 2/26

(52) U.S. Cl. CPC E04C 2/043; E04C 2/16; E04C 2/26; C04B 28/14; C04B 18/24; C04B 20/0068; C04B 18/248; C04B 2111/00629
USPC 428/141; 428/532; 442/327; 428/480; 428/475.5; 428/474.4; 428/523; 428/521; 428/537.7; 428/432; 428/454; 428/484.1; 428/447; 428/492; 428/413; 428/337; 106/780; 524/5; 106/774; 106/660; 524/3; 524/4; 524/2; 156/39

(57) ABSTRACT

A gypsum panel that incorporates a plant fiber other than paper is disclosed. The plant fiber material may be in the form of a facing material adhered to at least one side of the gypsum panel or in the form of loose fibers integrated with the gypsum panel as a matrix or both. Further, the plant fiber may be combined with conventional gypsum panel additives, is fully recyclable and environmentally sustainable. The present invention further relates to a method of making such a gypsum panel.

### FIELD OF THE INVENTION

The present invention relates to gypsum panels and, more particularly, to gypsum panels incorporating a bio-based material made from a plant fiber other than paper. Incorporation of the plant fiber material may be in the form of a facing material adhered to at least one side of the gypsum panel or in the form of loose fibers integrated with the gypsum panel as a matrix. The present invention further relates to a method of making such a gypsum panel.

### BACKGROUND OF THE INVENTION

Panels of gypsum wallboard having a core of set gypsum sandwiched between two sheets of facing paper have long been used as structural members in the fabrication of buildings. Such panels are typically used to form the partitions or walls of rooms, elevator shafts, stairwells, ceilings and the like. Paper facing provides a smooth surface that is especially desirable for painting or wall papering interior walls. Although paper is a relatively inexpensive facing material and is easily used in the process of manufacturing wallboard, it has certain well known disadvantages, particularly with regard to durability and moisture resistance.

In an effort to address the shortcomings of paper facing on gypsum wallboard (i.e., panels), other fibrous mats (such as glass fiber mats) also have been used as facing materials for gypsum wallboard as an alternative to paper facing. For example, a gypsum structural panel sandwiched between two porous fibrous mats is disclosed in U.S. Pat. No. 4,647,496. The preferred form of mat is described as a non-woven glass fiber mat formed from fiberglass filaments oriented in a random pattern and bound together with a resin binder. In such constructions, the set gypsum extends at least partially into the fibrous mat facer to form an integral attachment or bond between the gypsum and the glass fiber mat. Since the mat is completely porous, the gypsum flows freely into the pores (interstices) of the mat forming a strong bond with the mat.

Another example is Dens®-Armor Plus interior wallboard (available from Georgia-Pacific LLC, Atlanta, Ga.). Dens-Armor Plus uses a glass mat in place of cellulosic paper liner. Glass mat, while highly functional in this application, is not a biodegradable material nor is it easily recyclable when adhered to the gypsum panel.

Another example of such a wallboard is described in U.S. Pat. No. 3,993,822. Fibrous glass matting provides improved water resistance and often provides significant improvements in strength and other structural attributes. More recently, fibrous glass mats having various types of coatings also have found acceptance for use in applications requiring moisture resistance.

For example, U.S. Pat. Nos. 5,397,631 and 5,552,187 describe coated glass mats to further increase moisture resistance in an effort to address one of the main shortcomings of paper-faced gypsum panels. According to these patents, following the manufacture of a fibrous glass mat-faced gypsum panel, a surface of the panel faced with a glass mat is coated with a substantially humidity- and water-resistant resinous coating of a cured (dried) latex polymer. The coating acts as both a liquid and vapor barrier and is formed from an aqueous coating composition.

While this approach may solve problems encountered when using paper-faced gypsum panels in moist environments, the added cost, due both to the cost of the resinous coating itself and the cost associated with how the coating is applied, has been an impediment to wider use of such panels. As noted above, the glass mat is not a biodegradable material nor is it easily recyclable when adhered to the gypsum panel.

Commercially available gypsum board products with synthetic liners have also been developed. Canadian Patent No. 1,189,434 describes a synthetic sheet material as a substitute for the paper liners found in conventional gypsum board products. The patent discloses gypsum panels made with a facing of Tyvek® (DuPont) sheets. The gypsum board product made according to the '434 patent has several shortcomings. First, the product has been found to have poor adhesive bonding between the liner material and the gypsum slurry during the board manufacturing process. Second, although the Tyvek liner is at least as strong as paper, the board strength is only about one-third that of paper-lined standard gypsum board. Third, the surface of the gypsum board is shiny and almost film-like smooth, which is not a desirable surface for gypsum board. Finally, the melting point of Tyvek sheet is around 135 degrees C., and the sheet starts shrinking at temperatures close to 100 degrees C. This is a disadvantage because the drying ovens used in conventional gypsum board making processes operate at temperatures well above 100 degrees C., usually above 150 degrees C.

A recent driver in the industry is the need for recyclable, biodegradable materials applied to or integrated within gypsum wallboard or panels. Further, the recyclable materials need to be environmentally renewable and ideally possess most if not all of the positive qualities associated with paper and glass mat, e.g., dimensional stability, interfacial bonding to gypsum, mold and mildew resistance, strength, and good handling and weathering characteristics. Currently, these qualities are achieved at the expense of recyclability.

### SUMMARY OF THE INVENTION

It is therefore desired to provide by way of the present invention gypsum panel building material incorporating a bio-based material other than paper that is easily recyclable and renewable. The bio-based material may be incorporated with the gypsum panel in the form of a facing material on at least one surface having plant fiber other than paper or in the form of plant fiber other than paper integrated within the gypsum panel, forming a matrix of gypsum and biodegradable plant fiber. Alternatively, the gypsum panel of the present invention may incorporate plant fiber other than paper both in matrix form and as a facing material on at least one surface.

It is further desired to provide by way of the present invention a method of making gypsum panel building material incorporating plant fiber material as described above. The present invention provides a method of manufacturing a gypsum panel comprising the steps of preparing a gypsum slurry, applying a facing material comprising plant fibers other than paper to at least one face of the gypsum panel and curing and drying the gypsum slurry to form a set gypsum panel. The present invention further provides a method of manufacturing a gypsum panel comprising the steps of preparing a gypsum slurry, dispersing plant fibers other than paper within the gypsum slurry, and curing and drying the gypsum slurry to form a set gypsum panel integrated with biodegradable plant fibers. Alternatively, a gypsum panel of the present invention may be manufactured by integrating plant fibers other than paper with a gypsum panel combined with applying a facing material having plant fibers other than paper to the gypsum panel.

### BRIEF DESCRIPTION OF THE DRAWINGS

FIG. 1 is a picture view of the textured side of the facing material of the present invention.

FIG. 2 is a picture view of the smooth side of the facing material of the present invention.

FIG. 3 is a picture view of the facing material of the present invention installed on a gypsum panel.

### DETAILED DESCRIPTION OF THE INVENTION

The invention describes a gypsum panel having a facing material on at least one side made of plant fiber other than paper. Generally, a person having Ordinary skill in the art will readily know that for indoor applications, the side of the gypsum board that is exposed and visible is commonly known as the “face” side. The other side (also referred to as the “opposite side”) of the gypsum board is commonly known as the “back” side. This “back” side is in contact with the studs and the cavity behind the wall (also referred to as the “wall cavity”).

The facing material of the present invention may be placed on one or both sides of the gypsum panel. It is acceptable to have the facing material on both the face and the back sides of the gypsum panel, for example, to impart better impact resistance as described in U.S. Pat. No. 6,800,361. It may be more economically feasible, however, having the facing material on only one side of the gypsum panel of the present invention. In this case, the opposite side of the panel may be lined with some other substrate such as glass or paper.

The facing material can comprise continuous or discrete strands or fibers and can be woven or nonwoven in form. Nonwoven mats such as made from chopped strands and continuous strands can be used satisfactorily and arc less costly than woven materials. The strands of such mats typically are bonded together to form a unitary structure by a suitable adhesive.

One example of a plant fiber that may be used in manufacturing the facing material of the present invention is flax. Flax (a.k.a., linseed) fibers are known for the production of, for example, linens, twine, rope, cloth, and printed banknotes. Flax fiber is stronger than cotton fiber but less elastic. In addition, flax is plentiful and cost competitive with glass and paper. In accordance with the present invention, a gypsum panel may incorporate flax that has been spun into facing material to provide a gypsum panel having equivalent to superior dimensional stability, interfacial bonding, mold and mildew resistance, strength, and good handling and weathering characteristics. Further, flax fibers are completely biodegradable when the gypsum panel has reached the end of its useful life.

Another example of a plant fiber that may be used in manufacturing the facing material of the present invention is hemp (a.k.a., bast). Similar to flax, hemp is well known for its industrial applications in the manufacture of, for example, paper, textiles, plastics, health food and even fuel. Hemp demonstrates a high growth rate, producing approximately 10% more fiber than flax or cotton when grown on the same plot. Further, hemp requires no pesticides and few, if any, herbicides. In accordance with the present invention, a gypsum panel may incorporate hemp that has been spun into a facing material to provide a gypsum panel having equivalent to superior dimensional stability, interfacial bonding, mold and mildew resistance, strength, and good handling and weathering characteristics. Further, hemp fibers are completely biodegradable when the gypsum panel has reached the end of its useful life.

Still other examples of suitable plant fibers that may be used in manufacturing the facing material of the present invention include, but are not limited to, jute, kenaf, abaca (i.e., Manila hemp of the banana family), sabai grass, esparto grass (a.k.a., needle grass), straw, bagasse (e.g., from sugarcane or sorghum stalks), milkweed floss fibers, bamboo, or pineapple leaf fibers (a.k.a., pina). Some of these plants, such as jute and kenaf, produce two types of fiber. The first fiber is a coarser fiber in the outer layer and a finer fiber in the core. As stated above, all of the fibers are biodegradable when the gypsum panel has reached the end of its useful life.

The abovementioned plant fiber may further be blended or combined with a polymer to make the facing material of the present invention. Briefly, polymers are large macromolecules made of repeating structural units connected by covalent bonds. Natural polymers (e.g., natural rubber and cellulose) have been used for centuries in building and other products. Synthetic polymers (e.g., polyester, polypropylene, polyethylene, polybutylene, nylon, polyaramids or combinations thereof) may be blended with the plant fibers of the present invention to form a facing material with, for example, enhanced water resistant properties or superior weather resistance.

In the spirit of the present invention, the polymer may be a recyclable mono-component or bi-component fiber. A mono-component fiber is, simply, a fiber made from one polymer material. A bi-component fiber is produced by extruding two polymers from the same spinneret with both polymers contained within the same filament. Various combinations can be produced, such as side-by-side fibers (i.e., two components divided along the length into two or more distinct regions), sheath-core fibers (i.e., one of the components (core) is fully surrounded by the second component (sheath)), matrix-fibril (i.e., one component dispersed as strands within another component), and segmented pie structure, which includes hollow pie wedge and conjugate formations.

In one aspect of the invention, bi-component fibers would be useful in that they exploit capabilities not existing in either polymer alone. Indeed, the combinations described above are especially useful in certain situations. For example, sheath-core fibers have superior bonding characteristics and composite reinforcement properties when used to manufacture nonwoven material.

The polymer used in the present invention may be a biodegradable polymer. Generally, biodegradable polymers will degrade through the action of living organisms, light, air, water and combinations of the foregoing. Such polymers include a range of synthetic polymers, such as polyesters, polyester amides, polycarbonates and the like. Naturally-derived semi-synthetic polyesters (e.g. from fermentation) can also be used. In one aspect of the invention, biodegradable polymers can be polyethylene terephthalate, modified polyethylene terephthalate, polyesteramides, polylactic acid-based polymers, terpolymers based on polylactic acid, polyglycolic acid, polycaprolactone, polyalkylene carbonates, polyhydroxybutyrate (PHB), aliphatic-aromatic copolyesters, aliphatic polyesters (e.g., polyhydroxyvalerate, polyhydroxybutyrate-hydroxyvalerate copolymer and polycaprolactone), succinate-based aliphatic polymers (e.g., polybutylene succinate (PBS), polybutylene succinate adipate (PBSA), and polyethylene succinate (PBS)), or combinations thereof.

Besides being able to biodegrade, it is often important for a polymer or polymer blend to exhibit certain physical properties, such as stiffness, flexibility, water-resistance, strength, elongation, temperature stability, moisture vapor transmission, or dead-fold. The intended application of a particular facing material should dictate which properties are necessary in order to select polymers or polymer blends for a facing material manufactured therefrom to exhibit the desired performance criteria.

In this regard, certain polymers have “stiff” characteristics while others possess “soft” characteristics. Such classifications are useful when determining which polymers to blend together in order to obtain a polymer blend having the desired performance criteria. In general, those polymers that may be characterized as being relatively “stiff” or less flexible typically include polymers which have a glass transition temperature of from at least about 10 degrees C. to at least about 35.degree. C. The foregoing temperatures attempt to take into consideration the fact that the “glass transition temperature” is not always a discreet temperature but is often a range of temperatures within which the polymer changes from being a glassy and more brittle material to being a softer and more flexible material.

“Soft” (i.e., less rigid) polymers typically include polymers which have a glass transition temperature of less than about 0 degrees C. to less than about −30 degrees C. The foregoing temperatures attempt to account for the fact that the “glass transition temperatures” of “soft” polymers often comprise a range of temperatures. A thorough discussion of “stiff” and “soft” biodegradable polymers can be read in U.S. Pat. No. 7,172,814 to Hodson, herein incorporated by reference in its entirety.

Starch, depending on how it has been treated, may act as either a “stiff” or “soft” polymer. Modified starch or starch that has been gelatinized with water and subsequently dried is known to have a high glass transition temperature (i.e.: 70 degrees C. or higher) and be crystalline at room temperature. Certain forms of starch in which the crystallinity has been greatly reduced or destroyed altogether can have very low glass transition temperatures and may, in fact, constitute “soft” biodegradable polymers within the scope of the invention. Native or dried gelatinized starch can be used as particulate fillers in order to increase the dead-fold properties of nonwovens made from a particular polymer or polymer blend. Moreover, to the extent that starches become thermoplastic but retain a substantially portion of their crystallinity, such starches may act as “stiff” rather than “soft” polymers. Nevertheless, there exists a range of thermoplastic starch polymers that can behave as “soft” polymers. A complete discussion regarding starch treatment may be read in U.S. Pat. No. 5,362,777 to Tomka.

Other polymers that may be suitable, for example, as a plant fiber coating include any polymer which has ethylenically unsaturated double bonds that can undergo free-radical polymerization on exposure to electromagnetic radiation, such as UV radiation or electron beams. As understood by those skilled in the art, the content of ethylenically unsaturated double bonds in the polymer must be sufficient to ensure effective crosslinking of the polymer. Generally, a content of ethylenically unsaturated double bonds in the range from 0.01 to 1.0 mol/100 g of polymer, usually from 0.05 to 0.8 mol/100 g of polymer and most often from 0.1 to 0.6 mol/100 g of polymer will be sufficient.

Suitable polymers may have acryloxy, methacryloxy, acrylamido or methacrylamido groups, which may be bonded to the backbone of the polymer directly or through an alkylene groups. Such polymers generally include silicones, polyurethanes, polyesters, polyethers, epoxy resins, melamine resins and (meth)acrylate-based polymers and copolymers, having in each case ethylenically unsaturated groups. Polymers having acryloxy and/or methacryloxy groups are most common. Such polymers often are called silicone acrylates, polyurethane acrylates, acrylate-modified polyesters or polyester acrylates, epoxy acrylates, polyether acrylates, melamine acrylates and acrylate-modified copolymers based on (meth)acrylates. It also is possible to use ethylenically unsaturated polyesters as the radiation curable polymer.

The silicones having ethylenically unsaturated double bonds are generally linear or cyclic polydimethylsiloxanes that have allyl, methallyl, acryloyl or methacryloyl groups. The ethylenically unsaturated groups are bonded to the silicon atoms of the main backbone of the polydimethylsiloxane directly, via an oxygen atom, or via an alkylene group which is linear or branched and may be interrupted by one or more non-adjacent oxygen atoms. Acrylate and/or methacrylate groups are introduced into such silicones, for example, by esterifying Si—OH groups in the polydimethylsiloxanes with an appropriate acid chloride or an alkyl ester of the acid, for example the ethyl esters and methyl esters. Another method is to hydrosilylate the propynyl esters of ethylenically unsaturated carboxylic acids with dimethylchlorosilane and then react the chloroorganosilicon compound obtained in this fashion with a polydimethylsiloxane containing hydroxyl groups. Another functionalization method starts from polydimethylsiloxanes which have an .omega.-chloroalkyl group on a silicon atom, for example 3-chloropropyl or 2-methyl-3-chloropropyl. Such compounds may be modified with ethylenically unsaturated compounds containing hydroxyl groups in the presence of suitable bases, for example tertiary amines, such as triethylamine, to give ethylenically unsaturated polysiloxanes. Examples Of ethylenically unsaturated compounds containing hydroxyl groups are the esters of ethylenically unsaturated carboxylic acids with polyhydroxy compounds, eg. hydroxyalkyl acrylates and hydroxyalkyl methacrylates, such as hydroxyethyl (meth)acrylate, hydroxypropyl (meth)acrylate, 3-hydroxy-2,2-dimethylpropyl (met)acrylate, trimethylolpropane di(meth)acrylate and pentaerythritol di- or tri(meth)acrylate.

Ethylenically unsaturated epoxy resin derivatives suitable for use in the radiation curable formulations encompass in particular the reaction products of epoxy-group-containing compounds or oligomers with ethylenically unsaturated monocarboxylic acids, such as acrylic acid, methacrylic acid, crotonic acid and cinnamic acid. Instead of, or together with the monocarboxylic acids, it is also possible to use the monoesters of ethylenically unsaturated dicarboxylic acids with monoalcohols, such as methanol, ethanol, n-propanol, isopropanol, n-butanol, tert-butanol, n-hexanol and 2-ethylhexanol. Suitable epoxy-group-containing substrates encompass in particular the polyglycidyl ethers of polyhydric alcohols. These include the diglycidyl ethers of bisphenol A and of its derivatives, and moreover the diglycidyl ethers of oligomers of bisphenol A, obtained by reacting bisphenol A with the diglycidyl ether of bisphenol A, and furthermore the polyglycidyl ethers of novolacs. The reaction products of the ethylenically unsaturated carboxylic acids with the glycidyl ethers under consideration may be modified with primary or secondary amines. It is moreover possible to introduce further ethylenically unsaturated groups into the epoxy resin by reaction of hydroxyl groups in epoxy resins with suitable derivatives of ethylenically unsaturated carboxylic acids, eg. acid chlorides. Ethylenically unsaturated epoxy resins are well known to the person skilled in the art and are commercially available.

A thorough discussion of silicones and epoxy resin derivatives is found in U.S. Patent Application Publication No. 2009/0223618, incorporated by reference herein in its entirety.

In yet another aspect, the gypsum panel of the present invention may incorporate a facing material on at least one side comprising plant fiber other than paper blended with paper fiber, glass fiber, or clay. The positive attributes of paper fiber make it an attractive addition in the manufacture of gypsum panels, such as low cost, ease of installation, environmental friendliness, and paintability. Glass fiber offers, for example, better abrasion and dent resistance as well as superior moisture properties. Clay offers high fire and moisture resistance.

A further aspect of the present invention is a gypsum panel that incorporates a facing material on at least one side comprising plant fiber other than paper at least partially coated with wax, plaster or silicone. All offer improved moisture resistance to the gypsum panel; silicone may further offer superior heat resistance compared with wax.

A further aspect of the present invention includes a gypsum panel that incorporates a facing material on at least one side having plant fiber other than paper such that the facing material is textured on one side and smooth on the other. In one embodiment of the present invention, the smooth side of a nonwoven mat facing material having a smooth side and a textured side is placed into contact with the gypsum panel during manufacture and the textured side faces away from the gypsum panel.

Conventional practice holds that the external surface of the panel be as smooth as possible to provide a good painting surface. The unexpected benefit of a textured nonwoven facing material of the present invention is twofold. First, the textured surface has superior sound absorbing properties over a smooth texture of the same material. This is important for some construction applications, such as theaters, apartments, hotels, schools or auditoriums. Second, the textured surface of the facing material may have superior aesthetics compared with a smooth surface of the same material.

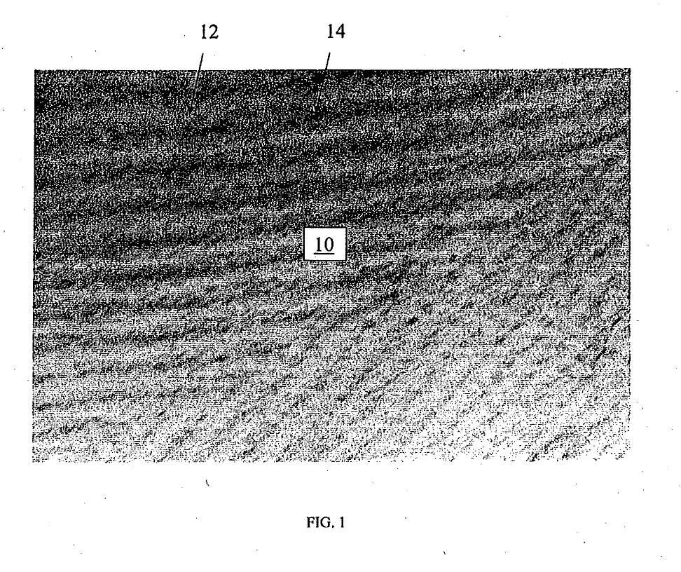

FIG. 1 is a picture view of the textured side of a facing material of the present invention (in this case a nonwoven mat (10)) made from hydroentangled hemp fibers. The texture is a herringbone pattern having ridges (12) and valleys (14) to impart a three-dimensional structure to the nonwoven mat (10). A nonwoven mat made from hydroentangled flax fibers was also prepared (not shown).

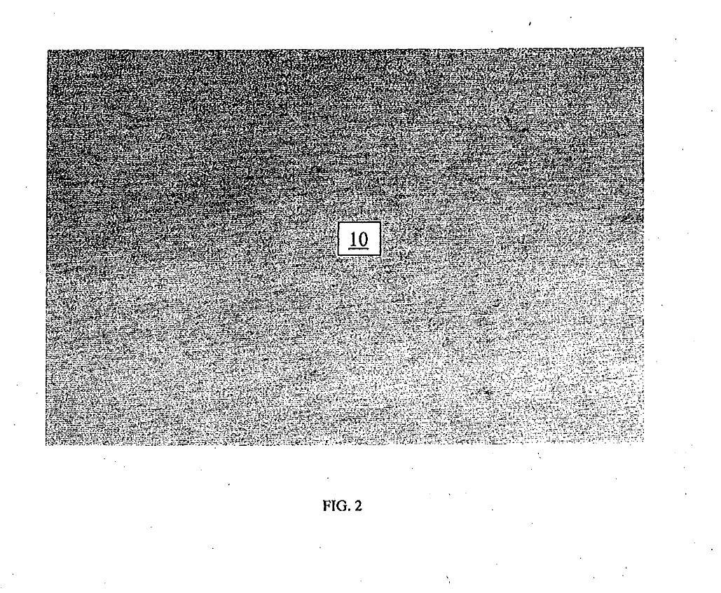

FIG. 2 is a picture view of the smooth side of the facing material of the present invention (e.g., the nonwoven mat (10)). As shown in FIG. 2, the smooth side of the nonwoven mat lacks the projections that are characteristic of the opposite textured side.

Being that “textured” and “smooth” are relative terms, it will be appreciated that generally, “smooth” means that the smooth side of the facing material of the present invention has an even, level surface compared with the “textured” side of the facing material. Given that the facing material of the present invention is fibrous (e.g., a woven or nonwoven mat), the “smooth” side of the facing material will be porous enough to accept and partially penetrate into a gypsum slurry. When the gypsum slurry sets, a strong adherent bond is formed between the gypsum and the facing material.

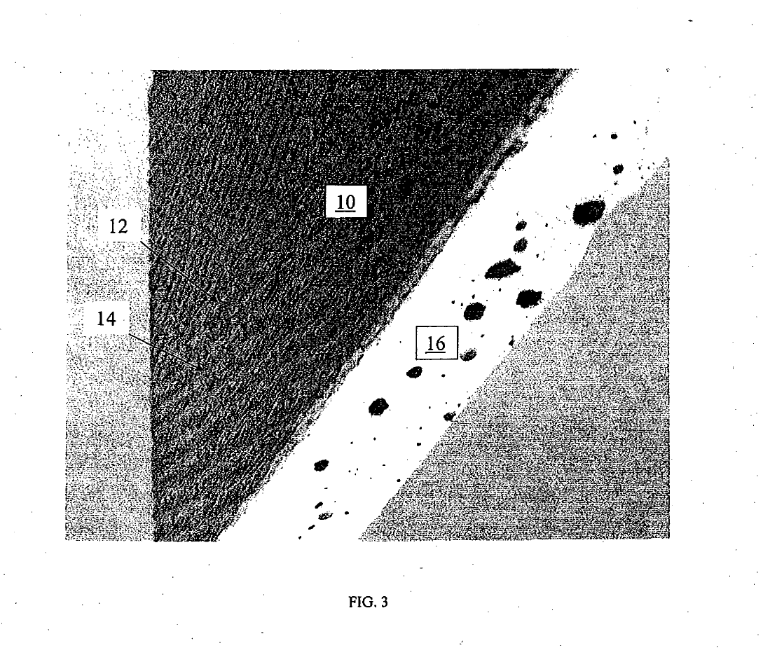

FIG. 3 is a picture view of the facing material of the present invention (e.g., the nonwoven mat (10)) made of hydroentangled hemp fibers installed on a gypsum panel (16). In one aspect of the present invention, the smooth side of the nonwoven mat (not shown) is placed onto the gypsum panel (16) and the textured side (defined by its ridges (12) and valleys (14)) faces away from the gypsum panel (16). Both sides of the facing material may also be smooth.

Conversely, in another aspect of the present invention, the textured side of the facing material may be placed onto the gypsum panel with the smooth side facing away. This may offer the advantage of a stronger bond with the gypsum slurry upon setting and a smoother surface facing outward for finishing. It will be understood that the degree of texturing of the facing material may offer advantages with respect to bonding with the gypsum panel up to a point where the texture of the textured side fails to contact the gypsum panel. In other words, if the textured side of the facing material does not fully embed into the gypsum slurry, gaps will remain between the facing material and the gypsum panel. This will result in a weaker bond between the facing material and the gypsum panel.

The gypsum panel of the present invention may be of variable thickness depending on its intended use. Typically, gypsum panels are from about 0.125 inches (i.e., about ⅛^{th} of an inch) thick to about two inches thick. The thickness of the facing material (e.g., a woven or nonwoven mat) may add to the overall thickness of the gypsum panel.

Facing material can range in thickness, for example, from about 10 to about 100 mils, with a mat thickness of about 15 to about 50 mils generally being suitable. While nonwoven fibrous mats may be preferred because of their lower cost, woven fibrous mats may be desirable in certain specialized instances and thus also are contemplated for use in connection with the present invention.

In another aspect, the invention encompasses the manufacture of a gypsum panel having a facing material on at least one side made of plant fiber other than paper. In this regard, the manufacture of the gypsum panel includes the steps of preparing a gypsum slurry, applying a facing material made of plant fibers other than paper to at least one side of the gypsum panel, and curing and drying the gypsum slurry to form a set gypsum panel.

It is within the scope of the present invention to apply the facing material to the gypsum slurry before it cures such that the facing material is enmeshed with the gypsum slurry upon drying to provide greater dimensional stability and interfacial bonding. It is also within the scope of the present invention to apply (e.g., adhere) the facing material to the gypsum panel after it dries.

Gypsum panel (i e., gypsum board) is typically manufactured by a method that includes dispersing a gypsum slurry onto a moving sheet of facing material. The facing material typically is supported by equipment such as forming tables, support belts, carrier rolls and/or the like. Usually a second sheet of facing material is then fed from a roll onto the top of the slurry, thereby sandwiching the slurry between two moving facing material sheets. Forming or shaping equipment is utilized to compress the slurry to the desired thickness. The gypsum slurry is allowed to at least partially set and then sequential lengths of board are cut and further processed by exposure to heat, which accelerates the drying of the board by increasing the rate of evaporation of excess water from the gypsum slurry.

The gypsum core of the panel of the present invention is basically of the type used in gypsum structural products commonly known as gypsum wallboard, dry wall, gypsum board, gypsum lath and gypsum sheathing. The core of such a product is formed by mixing water with powdered anhydrous calcium sulfate or calcium sulfate hemi-hydrate (CaSO₄.½H₂O), also known as calcined gypsum, to form an aqueous gypsum slurry, and thereafter allowing the slurry mixture to hydrate or set into calcium sulfate dihydrate (CaSO₄.2H₂O), a relatively hard material. The core of the product will in general comprise at least about 75-85 wt % of set gypsum, though the invention is not limited to any particular content of gypsum in the core.

After the gypsum slurry is deposited upon the facing material, the edges of the facing material are progressively folded (using equipment well-known to those skilled in the art) around the edges of the forming panel and terminate on the upper surface of the slurry along the sides. Another sheet of facing material typically is applied to the upper surface (top) of the gypsum slurry and usually only slightly overlaps the folded-around edges of the bottom facing material. Prior to applying the top facing material to the upper surface of the gypsum slurry, glue may be applied to the facing material along portions of the facing material that will overlap and be in contact with the folded-over edges of the bottom facing material sheet. Preferably non-starch-based glues are used. One suitable glue is a poly(vinyl alcohol) latex glue. Glues based on vinyl acetate polymers, especially vinyl acetate that has been hydrolyzed to form a polyvinyl alcohol, are widely available commercially as white glues.

After the top facing material is applied, the “sandwich” of top facing material, gypsum slurry and bottom facing material are pressed to the desired wallboard thickness between plates. Alternatively, the facing material and slurry can be pressed to the desired thickness with rollers or in another manner.

A complete and thorough explanation of the gypsum panel manufacturing process may be read in U.S. Patent Application Publication No. 2009/0223618, herein incorporated by reference in its entirety.

In one aspect of the invention, the step of applying a facing material made of plant fibers other than paper to at least one side of the gypsum slurry includes applying a woven or nonwoven mat of plant fibers.

Accordingly, the plant fibers forming the facing material will exhibit all of the characteristics described above. By way of example, a nonwoven mat of facing material can be applied to a gypsum slurry.

Nonwoven mats of facing material may be constructed various ways. For example, nonwoven mats may be made using a wet-laid process or a hydroentanglement process. The wet-laid process is carried out on what can be viewed as modified papermaking machinery. Descriptions of the wet-laid process for making nonwoven mats may be found in a number of U.S. patents, including U.S. Pat. Nos. 2,906,660, 3,012,929, 3,050,427, 3,103,461, 3,228,825, 3,760,458; 3,766,003, 3,838,995, 3,905,067, 4,112,174, 4,681,802 and 4,810,576, all of which are incorporated herein by reference.

In general, the wet-laid process for making nonwoven mats includes′first forming an aqueous slurry of short-length fibers (referred to in the art as “white water”) under agitation in a mixing tank, then feeding the slurry onto a moving screen. The fibers then enmesh themselves into a freshly prepared fiber mat, while excess water is separated from the mat of fibers. Most of the fibers used to make the mat have a length somewhere between about one-quarter (¼) to about one (1) inch, and have diameters in the range of 10 to 50 microns.

Machines such as wire cylinders, Fourdrinier machines, Stevens Former, Roto Former, Inver Former and Venti Former machines and the like can be used to form the wet-laid nonwoven mat. In such equipment, a head box deposits the dilute slurry onto a moving wire screen. Suction or vacuum removes the water resulting in the wet-laid mat. Usually, an upwardly inclined wire having several linear feet of very dilute stock lay-down, followed by several linear feet of high vacuum water removal, is used. This is followed by a binder applicator, such as a “curtain coater,” that applies the fiber binder. An oven then removes excess water and cures (dries) the adhesive to form a coherent fiber mat structure. A thorough discussion of the wet-laid process may be read in U.S. Patent Application Publication No. 2009/0084514, herein incorporated by reference in its entirety.

As stated above, a hydroentanglement process may also be employed for making a nonwoven mat facing material in accordance with the present invention. A known hydroentangling method includes treating a fibrous facing material by means of high-pressure water jets for the purpose of entangling all or some of the fibers and for modifying some of the facing material's properties. The aim in particular of this method is to modify the mechanical strength and the linting of the facing material. The facing material is supported by a porous support wire which moves in a direction perpendicular to the alignments of the water jets. The water jets are produced by an apparatus comprising one or more injectors placed across the direction of movement of the facing material. Typically, an injector comprises a high-pressure chamber in the form of a channel that communicates on one side with a plate provided with calibrated perforations, of circular shape, all with the same diameter and of suitable profile. A suitable hydroentanglement method and improvement thereof is described in U.S. Pat. Nos. 7,467,445 and 7,669,304, herein incorporated by reference in their entirety. Other hydroentanglement methods are known to a person having ordinary skill in the art.

### Example 1

By way of example, a nonwoven facing material made of hydroentangled hemp fibers was set to a gypsum panel using manufacturing techniques generally described above. Excess water was dried and the gypsum panel incorporating the nonwoven hemp fiber facing material was dried at approximately 110 degrees C. for 48 hours prior to evaluation of its physical properties. Table 1 illustrates the results of a nail pull test using three samples of 100% nonwoven hemp facing material and three samples of a blend of 80% hemp and 20% polyethylene terephthalate (PET).

TABLE 1

| Sample | Sample | Board Weight | Nail Pull |
|---|---|---|---|
| ID | Weight (g) | (#/MSF) | (#f) |
| 100 A | 117.3 | 2325 | 74.8 |
| 100 B | 117.9 | 2337 | 68.9 |
| 100 C | 121.2 | 2403 | 60.3 |
| 80 A | 123.2 | 2442 | 58.8 |
| 80 B | 123.7 | 2452 | 50.5 |
| 80 C | 121.5 | 2409 | 67.4 |

Board weight is measured in pounds per thousand square feet (#/MSF). Nail pull is measured in pound feet as per ASTM C473 or similar.

In addition, the mold and mildew resistant properties (i.e., MM rating) of a sample of 100% hemp hydroentangled nonwoven facing material and a sample of a blend of 80% hemp and 20% PET hydroentangled nonwoven facing material, both set to a gypsum panel using manufacturing techniques generally described above, were compared with Georgia-Pacific products DensGlass® Gold (DGG), Mold Guard paper, and a wooden block. Mold and mildew resistance was measured on the face of the board and the back of the board with the facing material installed on both surfaces.

TABLE 2

| | MM Rating |
|---|---|
| Sample | (Face/Back) |
| 100% Hemp | 9.0/8.7 |
| 80% Hemp | 9.2/9.2 |
| DGG | 10/10 |
| Mold Guard Paper | Typically 10 |
| Wood Block | Typically 0-3 |

Table 2 shows that the hemp facing material compares well with DensGuard Gold and Mold Guard paper and far outperforms the wooden block. ASTM D 3273 or similar was the standard used.

### Example 2

By further way of example, nonwoven flax facing material was applied to a gypsum panel using manufacturing techniques generally described above. Two flax formulations (100% flax and 80% flax/20% PET) were compared with Georgia-Pacific products ToughRock® paper and DensGlass® for various performance parameters as shown in Table 3 below.

TABLE 3

| Performance | Flax- | Flax80/ | ToughRock | |
|---|---|---|---|---|
| Metrics | 100% | PET20 | Paper | DensGlass |
| Nail Pull | 8 | 8 | 10 | 8 |
| Interfacial adhe- | 10 | 10 | 8 | 10 |
| sion of mat | | | | |
| Breathability to | 10 | 10 | 8 | 10 |
| moisture | | | | |
| Processability | 8 | 8 | 10 | 10 |
| Environmental | 10 | 10 | 8 | <5 |
| friendliness | | | | |
| Surface abrasion | 8 to 10 | 8 to 10 | 6 | 6 |
| Paintability/ | <5 | <5 | 10 | 7 |
| finishing | | | | |
| Weathering | TBD | TBD | <5 | 10 |
| Printability | OK-TBD | OK-TBD | OK | OK |
| Mold and Mildew | TBD | TBD | <5 | 10 |

8-10-Good
5-8-Medium
<5-Poor

In yet another aspect, the invention encompasses a gypsum panel having plant fiber other than paper integrated within the gypsum panel, forming a matrix of gypsum and plant fiber. Accordingly, the plant fibers integrated within the gypsum panel will include all of the characteristics described above with respect to the type of plant fiber other than paper, blending or coating the plant fiber other than paper with a polymer or combination of polymers (e.g., mono- or bicomponent polymer fibers), blending the plant fiber other than paper with paper or glass fibers, blending the plant fiber other than paper with clay; and at least partially coating the plant fibers with wax, silicone, latex, plaster, or an epoxy resin.

In a further aspect, the invention encompasses a method of manufacturing a gypsum panel having plant fiber other than paper integrated within the gypsum panel, including the steps of preparing a gypsum slurry, dispersing plant fibers other than paper within the gypsum slurry, and curing and drying the gypsum slurry to form a set gypsum panel integrated with plant fibers. As stated above, the gypsum panel manufacturing process is generally as described herein and incorporated by reference. The plant fibers other than paper will include all of the characteristics described above with respect to the type of plant fiber other than paper, blending or coating the plant fiber other than paper with a polymer or combination of polymers (e.g., mono- or bicomponent polymer fibers), blending the plant fiber other than paper with paper or glass fibers, blending the plant fiber other than paper with clay, and at least partially coating the plant fibers with wax, silicone, latex, plaster, or an epoxy resin.

Preliminary results with respect to nail pull on a gypsum panel having a plant fiber other than paper integrated within the gypsum panel are positive. Flak and hemp fibers were dispersed in a gypsum matrix as described and tested for nail pull (data not shown).

In a further aspect, the invention encompasses a gypsum panel having plant fiber other than paper integrated within the gypsum panel, forming a matrix of gypsum and plant fiber, and further having a facing material made of plant fiber other than paper on at least one surface of the gypsum panel. The plant fibers other than paper will include all of the characteristics described above with respect to the type of plant fiber other than paper, blending or coating the plant fiber other than paper with a polymer or combination of polymers (e.g., mono- or bicomponent polymer fibers), blending the plant fiber other than paper with paper or glass fibers, blending the plant fiber other than paper with clay, and at least partially coating the plant fibers with wax, silicone, latex, plaster, or an epoxy resin.

Accordingly, both hemp and flax could provide the much needed sustainability solution to the gypsum industry without sacrificing the performance shown by the glass mat or paper faced products. It will be understood that while the invention has been described in conjunction with certain embodiments, the foregoing description and examples are intended to illustrate, but not limit the scope of the invention. Other aspects, advantages and modifications will be apparent to those skilled in the art to which the invention pertains, and these aspects and modifications are within the scope of the invention, which is defined by the appended claims.

1. A gypsum panel having a facing material on at least one side comprising plant fiber other than paper.

2. The gypsum panel of claim 1, wherein the facing material comprises a nonwoven plant fiber.

3. The gypsum panel of claim 1, wherein the plant fiber comprises flax.

4. The gypsum panel of claim 1, wherein the plant fiber comprises hemp

5. The gypsum panel of claim 1, wherein the plant fiber is selected from the group consisting of flax, hemp, jute, kenaf, abaca, sabai grass, esparto grass, straw, bagasse, milkweed floss fibers, bamboo, and pineapple leaf fibers.

6. The gypsum panel of claim 1, wherein the plant fiber is blended with a polymer.

7. The gypsum panel of claim 6, wherein the polymer is selected from the group consisting of polyester, polypropylene, polyethylene, polybutylene, nylon, polyaramids, polyethylene terephthalate, modified polyethylene terephthalate, polyesteramides, polylactic acid-based polymers, terpolymers based on polylactic acid, polyglycolic acid, polycaprolactone, polyalkylene carbonates, polyhydroxybutyrate (PHB), aliphatic-aromatic copolyesters, aliphatic polyesters, starch, and succinate-based aliphatic polymers.

8. The gypsum panel of claim 6, wherein the polymer is a mono-component fiber.

9. The gypsum panel of claim 6, wherein the polymer is a bi-component fiber.

10. The gypsum panel of claim 1, wherein the facing material further comprises a smooth side and a textured side, the smooth side being placed in contact with the gypsum panel and the textured side facing away from the gypsum panel.

11. The gypsum panel of claim 1, wherein the facing material further comprises a smooth side and a textured side, the textured side being placed in contact with the gypsum panel and the smooth side facing away from the gypsum panel.

12. The gypsum panel of claim 1, wherein the plant fiber is blended with paper fiber.

13. The gypsum panel of claim 1, wherein the plant fiber is blended with glass fiber.

14. The gypsum panel of claim 1, further comprising plant fiber other than paper blended with clay.

15. The gypsum panel of claim 1, wherein the plant fiber is at least partially coated with wax.

16. The gypsum panel of claim 1, wherein the plant fiber is at least partially coated with silicone.

17. The gypsum panel of claim 1, wherein the plant fiber is at least partially coated with a coating material selected from the group consisting of latex, plaster and epoxy resin.

18. The gypsum panel of claim 1, wherein the gypsum panel has a thickness of from about 0.125 inches to about 2.0 inches.

19. A method of manufacturing a gypsum panel comprising the steps of:
preparing a gypsum slurry;
applying a facing material comprising plant fibers other than paper to at least one side of the gypsum panel; and
curing and drying the gypsum slurry to form a set gypsum panel.

20.-27. (canceled)

28. The method of claim 19, wherein the facing material comprising fibers other than paper further comprises a substantially smooth side and a textured side.

29. The method of claim 28, wherein the step of applying the facing material comprising plant fibers other than paper comprises applying the substantially smooth side of the facing material to the gypsum panel.

30. The method of claim 28, wherein the step of applying the facing material comprising plant fibers other than paper comprises applying the textured side of the facing material to the gypsum panel.

31.-37. (canceled)

38. A gypsum panel comprising plant fiber other than paper integrated within the gypsum panel, forming a matrix of gypsum and plant fiber.

39. The gypsum panel of claim 38, wherein the plant fiber comprises flax.

40. The gypsum panel of claim 38, wherein the plant fiber comprises hemp.

41. The gypsum panel of claim 38, wherein the plant fiber is selected from the group consisting of flax, hemp, jute, kenaf, abaca, sabai grass, esparto grass, straw, bagasse, milkweed floss fibers, bamboo, and er-pineapple leaf fibers.

42. The gypsum panel of claim 38, wherein the plant fiber is blended with a polymer.

43. The gypsum panel of claim 42, wherein the polymer is selected from the group consisting of polyester, polypropylene, polyethylene, polybutylene, nylon, polyaramids, polyethylene terephthalate, modified polyethylene terephthalate, polyesteramides, polylactic acid-based polymers, terpolymers based on polylactic acid, polyglycolic acid, polycaprolactone, polyalkylene carbonates, polyhydroxybutyrate (PHB), aliphatic-aromatic copolyesters, aliphatic polyesters, starch, and succinate-based aliphatic polymers.

44. The gypsum panel of claim 42, wherein the polymer is a mono-component fiber.

45. The gypsum panel of claim 42, wherein the polymer is a bi-component fiber.

46. The gypsum panel of claim 38, further comprising a facing material comprising plant fiber other than paper on at least one surface of the gypsum panel.

47. The gypsum panel of claim 46, wherein the facing material is a nonwoven mat.

48. The gypsum panel of claim 46, further comprising a facing material having a smooth side and a textured side, the smooth side being placed in contact with the gypsum panel and the textured side facing away from the gypsum panel.

49. The gypsum panel of claim 46, further comprising a facing material having a smooth side and a textured side, the textured side being placed in contact with the gypsum panel and the smooth side facing away from the gypsum panel.

50. The gypsum panel of claim 38, wherein the plant fiber is blended with paper fiber.

51. The gypsum panel of claim 38, wherein the plant fiber is blended with glass fiber.

52. The gypsum panel of claim 38, further comprising plant fiber other than paper blended with clay.

53. The gypsum panel of claim 38, wherein the plant fiber is at least partially coated with wax.

54. The gypsum panel of claim 38, wherein the plant fiber is at least partially coated with silicone.

55. The gypsum panel of claim 38, wherein the plant fiber is at least partially coated with a coating material selected from the group consisting of latex, plaster and epoxy resin.

56. The gypsum panel of claim 46, wherein the facing material is blended with paper fiber.

57. The gypsum panel of claim 46, wherein the facing material is blended with glass fiber.

58. The gypsum panel of claim 46, wherein the facing material is blended with clay.

59. The gypsum panel of claim 46, wherein the plant fiber is at least partially coated with wax.

60. The gypsum panel of claim 46, wherein the plant fiber is at least partially coated with silicone.

61. The gypsum panel of claim 46, wherein the plant fiber is at least partially coated with a coating material selected from the group consisting of latex, plaster and epoxy resin.

62. The gypsum panel of claim 38, wherein the gypsum panel has a thickness of from about 0.125 inches to about 2.0 inches.

63. A method of manufacturing a gypsum panel comprising the steps of:
preparing a gypsum slurry;
dispersing plant fibers other than paper within the gypsum slurry; and
curing and drying the gypsum slurry to form a set gypsum panel integrated with plant fibers.

64.-70. (canceled)

71. The method of claim 63, further comprising the step of applying a facing material comprising plant fiber other than paper on at least one surface of the gypsum panel.

72. (canceled)

73. The method of claim 71, wherein:
the facing material comprising fibers other than paper further comprises a substantially smooth side and a textured side, and
the step of applying the facing material comprising plant fibers other than paper comprises applying the substantially smooth side of the facing material to the gypsum panel.

74. The method of claim 71, wherein:
the facing material comprising fibers other than paper further comprises a substantially smooth side and a textured side, and
the step of applying the facing material comprising plant fibers other than paper comprises applying the textured side of the facing material to the gypsum panel.

75.-87. (canceled)
